(19) United States
(12) Patent Application Publication
(10) Pub. No.: US 2008/0029246 A1
(43) Pub. Date: Feb. 7, 2008

(54) HEAT EXCHANGER BYPASS SYSTEM

(75) Inventors: Matthew Fratantonio, Northborough, MA (US); Wayne R. Duprez, Waltham, MA (US); Daniel E. Spurr, Gardner, MA (US)

Correspondence Address: BARNES & THORNBURG LLP, 11 SOUTH MERIDIAN, INDIANAPOLIS, IN, 46204, US

(73) Assignee: STANDARD-THOMSON CORPORATION, Waltham, MA (US)

(21) Appl. No.: 11/686,822

(22) Filed: Mar. 15, 2007

Related U.S. Application Data
(60) Provisional application No. 60/743,504, filed on Mar. 16, 2006.

(51) Int. Cl. G05D 23/13; F28F 27/02

(52) U.S. Cl. 165/103

(57) ABSTRACT

A fluid regulator includes a temperature-responsive bypass valve and a valve return spring. The bypass valve is arranged to cause fluid discharged from a fluid beater (such as a transmission) coupled to the fluid regulator to bypass a heat exchanger coupled to the fluid regulator until the fluid is hot and has a temperature in excess of a certain threshold level.

This application claims priority under 35 U.S.C. § 119(e) to U.S. Provisional Application Ser. No. 60/743,504, filed Mar. 16, 2006, which is expressly incorporated by reference herein.

### BACKGROUND

The present disclosure relates to heat exchangers and, in particular, to heat exchangers for cooling hot fluids used onboard vehicles. More particularly, the present disclosure relates to heat exchanger bypass systems.

A heat exchanger is used to cool certain fluids such as engine oil and transmission fluid onboard a vehicle. It is desirable to block circulation of these vehicle fluids through a heat exchanger during, for example, “engine start-up” cycle, when the vehicle fluids are “cold” and therefore do not need to be “cooled.” During these “cold fluid” conditions, the fluids are allowed to circulate in the engine and transmission and are not allowed to flow through the heat exchanger. A heat exchanger bypass valve is disclosed, for example, in U.S. Pat. No. 6,253,837, which patent is incorporated herein in its entirety.

### SUMMARY

A fluid regulator in accordance with the present disclosure includes a fluid-control housing and a fluid-flow controller in the fluid-control housing. The fluid-control housing includes first and second fluid-transfer passageways and a cooler bypass passageway arranged to interconnect the first and second fluid-transfer passageways in fluid communication. The fluid-flow controller includes a temperature-responsive bypass valve and a valve return spring associated with the bypass valve. The bypass valve and the valve return spring are both located in the second fluid-transfer passageway.

In illustrative embodiments, the first fluid-transfer passageway is configured to conduct transmission fluid discharged from a transmission to a heat exchanger. The second fluid-transfer passageway is configured to return transmission fluid discharged from the heat exchanger to the transmission. No return spring is located in the first fluid-transfer passageway or in the cooler bypass passageway.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompany figures in which:

FIG. 1 is a diagrammatic view of a vehicle transmissions system including a transmission, a heat exchanger, and a fluid regulator in accordance with the present disclosure for controlling circulation of transmission fluid through the transmission and through the heat exchanger, the fluid regulator including a first fluid-transfer passageway interconnecting a first transmission port and a first cooler port formed in a lower portion of a fluid-control housing, a second fluid-transfer passageway interconnecting a second transmission port and a second cooler port formed in an upper portion of the fluid-control housing, and a cooler bypass passageway interconnecting the first and second fluid-transfer passageways, and showing that the second fluid-transfer passageway contains a fluid-flow controller comprising a partition plate formed to include a fluid-transfer orifice, a movable temperature-responsive bypass valve arranged to extend through the fluid-transfer orifice and a valve mover spring arranged to urge the bypass valve to a “raised” low-temperature position to (1) open the cooler bypass passageway so that transmission fluid discharged from the transmission can flow therethrough to return to the transmission without flowing through the heat exchanger and (2) close the fluid-transfer orifice when transmission fluid extant in the second fluid-transfer passageway is “cold” (as during engine startup) and has a temperature below a minimum threshold temperature so that transmission fluid discharged from the first fluid-transfer passageway through the first cooler port into the heat exchanger is blocked by the bypass valve from flowing through the second fluid-transfer passageway back into the transmission;

FIG. 2 is a diagrammatic view similar to FIG. 1 showing movement of the temperature-responsive bypass valve in the second fluid-transfer passageway to a “lowered” high-temperature position to (1) block flow from the first fluid-transfer passageway to the second fluid-transfer passageway through the cooler bypass passageway when the temperature of transmission fluid extant in the second fluid-transfer passageway rises to a temperature above the minimum threshold temperature and (2) open the fluid transfer orifice so that “hot” transmission fluid flowing from the heat exchanger into the second fluid-transfer passageway through the second cooler port can flow to the transmission through the second transmission port; and

FIG. 3 is a diagrammatic view similar to FIGS. 1 and 2 showing the temperature-responsive bypass valve in the lowered high-temperature position but also showing movement of a vacuum-relief valve located under the temperature-responsive bypass valve in the second fluid-transfer passageway in an upward direction relative to the temperature-responsive bypass valve and against a downward biasing force applied by the valve mover spring to “open” the cooler bypass passageway even though the temperature of transmission fluid in the second fluid-transfer passageway remains above the minimum threshold temperature.

### DETAILED DESCRIPTION

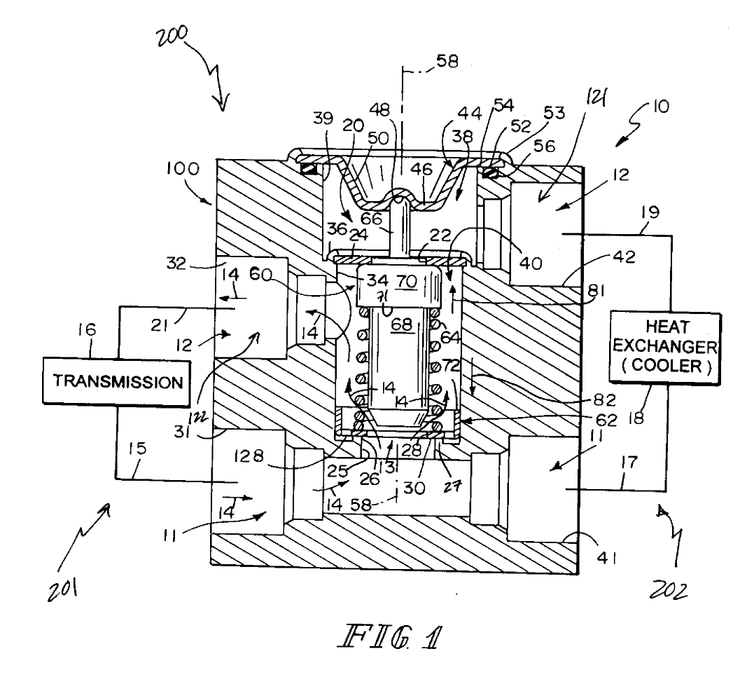

A heat exchanger bypass system 200 in accordance with the present disclosure includes a fluid heater 201, a fluid cooler 202, and a fluid regulator 10. Fluid regulator 10 functions to cause fluid discharged from fluid heater 201 to flow through fluid cooler 202 only when the temperature of that fluid exceeds a predetermined minimum temperature. In an illustrative embodiment, fluid heater 201 includes a transmission 16, a fluid discharge conduit 15, and a fluid intake conduit 21 and fluid cooler 202 includes a heat exchanger 18, a fluid intake conduit 17, and a fluid discharge conduit 19 as suggested diagrammatically in FIG. 1.

A fluid regulator 10 in accordance with the present disclosure includes a fluid-control housing 100 formed to include first and second fluid-transfer passageways 11, 12 and a cooler bypass passageway 13 interconnecting first and second fluid-transfer passageways 11, 12 as suggested in FIG. 1. First fluid-transfer passageway 11 is adapted to conduct transmission fluid 14 discharged from transmission 16 to a heat exchanger (cooler) 18. Second fluid-transfer passageway 12 is adapted to conduct transmission fluid 14 discharged from heat exchanger 18 to transmission 16. Fluid regulator 10 also includes a fluid-flow controller 20 located in second fluid-transfer passageway 12 and configured to control flow of transmission fluid 14 both (1) through second fluid-transfer passageway 12 and (2) into second fluid-transfer passageway 12 from cooler bypass passageway 13.

Whenever the temperature of transmission fluid 14 discharged from transmission 16 is relatively cold (i.e., below a predetermined minimum threshold temperature), it is desirable to cause that cold transmission fluid 14 to “bypass” heat exchanger 18 and instead flow from first fluid-transfer passageway 11 to second fluid-transfer passageway 12 through cooler bypass passageway 13. Transmission fluid 14 is often cold at the beginning of an engine-startup cycle. Cold transmission fluid has a high viscosity (i.e., resistance to flow) and does not flow easily through many heat exchangers and could lead to poor return of transmission fluid to transmission 16.

As suggested in FIG. 1, during such a low fluid-temperature condition, fluid-flow controller 20 operates to “close” a fluid-transfer orifice 22 formed in a partition plate 24 (or other suitable structure) partitioning second fluid-transfer passageway 12 and to “open” a plug-receiving aperture 28 formed in a valve plate 30 associated with an outlet 26 of cooler bypass passageway 13. Partition plate 24 is arranged to divide second fluid-transfer passageway 12 into an upstream portion 121 coupled to fluid discharge conduit 19 of fluid cooler 201 and a downstream portion 122 coupled to fluid intake conduit 21 of fluid cooler 202 as suggested in FIGS. 1-3. Fluid-flow controller 20 operates to divert cold transmission fluid 14 through an “opened” cooler bypass passageway 13 so that transmission fluid 14 does not flow through heat exchanger 18 before it is returned to transmission 16.

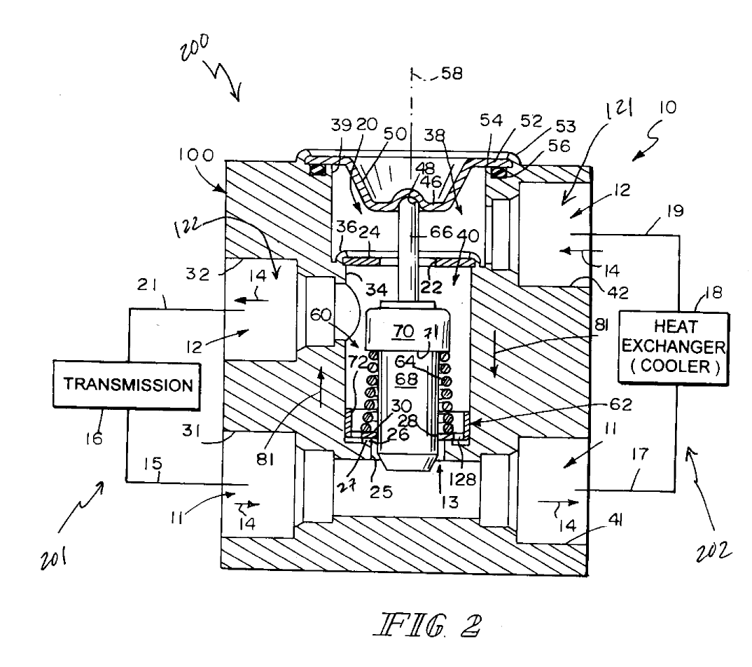

Whenever the temperature of transmission fluid 14 discharged from transmission 16 is relatively hot (i.e., above a predetermined minimum threshold temperature), it is desirable normally to “close” cooler bypass passageway 13 causing hot transmission fluid 14 to flow through heat exchanger 18 as suggested in FIG. 2. Transmission fluid 14 will heat up to a hot temperature after the engine has been running for awhile. Heat exchanger 18 is configured to cool hot transmission fluid 14 before it is discharged into second fluid-transfer passageway 12 and returned to transmission 16. As suggested in FIG. 2, during such a high-temperature condition, fluid-flow controller 20 operates to “open” fluid-transfer orifice 22 formed in partition plate 24 and to “close” plug-receiving aperture 28 formed in plate 30 located near outlet 26 of cooler bypass passageway 13 so that hot transmission fluid 14 always flows through heat exchanger 18 before it is returned to transmission 16. Relatively hot transmission fluid 14 has a low viscosity and flows easily through many heat exchangers.

In an illustrative embodiment, fluid-control housing 100 is formed to include a first transmission port 31 coupled to a fluid discharge conduit 15 mated to transmission 16 and a first cooler port 41 coupled to a fluid intake conduit 17 mated to heat exchanger 18. First fluid transfer passageway 11 is arranged to interconnect first transmission port 31 and first cooler port 41 in fluid communication as suggested in FIG. 1.

Fluid-control housing 100 is also formed to include a second cooler port 42 coupled to a fluid discharge conduit 19 mated to heat exchanger 18 and a second transmission port 32 coupled to a fluid intake conduit 21 mated to transmission 16 as shown, for example, in FIG. 1. Second fluid-transfer passageway 12 is arranged to interconnect second cooler port 42 and second transmission port 32 in fluid communication (when fluid-transfer orifice 22 is opened) as suggested in FIG. 1.

In an illustrative embodiment, partition plate 24 is retained on an annular seat 34 by a plate retainer 36 included in housing 100 to partition second fluid-transfer passageway 12 as shown, for example, in FIG. 1. Second fluid-transfer passageway 12 is divided by partition plate 24 to form (1) a piston chamber 38 communicating with second cooler port 42 and a valve access opening 39 formed in an exterior wall 101 of housing 100 and (2) a motor chamber 40 communicating with second transmission port 42 and outlet 26 of cooler bypass passageway 13. Cooler bypass passageway 13 also includes an inlet 25 communicating with first fluid-transfer passageway 11.

A base 44 is coupled to housing 100 to close valve access opening 39 as suggested in FIG. 1. It is within the scope of the present disclosure to form housing 100 to include base 44 or portions of base 44.

In an illustrative embodiment, base 44 includes a piston support plate 46 formed to include a central piston-receiving cavity 48 opening toward partition plate 30, a frustoconical ring 50 having a small-diameter end coupled to a perimeter edge of piston support plate 46, and an annular mount flange 52 having an inner edge coupled to a large-diameter end of frustoconical ring 50. Annular mount flange 52 is retained by a flange retainer 53 included in housing 100 on an annular seat 54 formed in housing 100 adjacent to valve access opening 39 and against a sealing gasket 56 located in a gasket-receiving channel formed in housing 100 as suggested in FIG. 1. In this retained position, piston support plate 46 and frustoconical ring 50 are arranged to extend into a central cavity formed in housing 100 to form a portion of the boundary of second fluid-transfer passageway 12. Piston-support plate 46 is arranged to lie in spaced-apart relation to partition plate 24 to align fluid-transfer orifice 22 with central piston-receiving cavity 48 along a central axis 58 extending through cooler bypass passageway 13 as shown in FIG. 1.

In an illustrative embodiment, fluid-flow controller 20 comprises a temperature-responsive bypass valve 60, a relief valve 62, and a valve mover spring 64 as suggested in FIG. 1. Valve mover spring 64 is arranged to apply a biasing force to each of bypass valve 60 and relief valve 62 to provide means for yieldably urging bypass valve 60 and relief valve 66 to move in opposite directions 81, 82 in second fluid-transfer passageway 12 as suggested in FIGS. 1-3.

Bypass valve 60 comprises a piston 66 arranged to extend through fluid-transfer orifice 22 formed in partition plate 24 to engage and seat in central piston-receiving cavity 48 formed in piston support plate 46 and a body 67 coupled to piston 66 and configured to be moved relative to piston 66 as suggested in FIGS. 1 and 2. Body 67 includes a closure plug 68 arranged to extend toward cooler bypass passageway 13 and a thermal motor 70 coupled to piston 66 and to closure plug 68.

Relief valve 62 comprises valve plate 30 and a cylindrical guide sleeve 72 coupled to a perimeter edge of valve plate 30 and arranged to extend toward base 44, as shown, for example, in FIG. 1. Valve plate 30 is formed to include a central plug-receiving aperture 28 and several smaller diameter flow-discharge apertures 128 located in a peripheral portion of valve plate 30 near the perimeter thereof.

Valve mover spring 64 is configured and arranged normally to urge temperature-responsive bypass valve 60 in a first direction 81 toward base 44 and away from cooler bypass passageway 13 to engage partition plate 24 and close fluid-transfer orifice 22. In an illustrative embodiment, valve mover spring 64 is a coiled compression spring arranged to wind around plug 68. Valve mover spring 64 has a narrow-diameter end arranged to engage an annular spring-mount flange 71 provided on an underside of thermal motor 70 as shown in FIG. 1. Valve mover spring 64 has a central axis that is arranged to lie in coextensive relation to central axis 58 of cooler bypass passageway 13 as suggested in FIG. 1.

Valve mover spring 64 is also configured and arranged normally to urge relief valve 62 in an opposite second direction 82 away from base 44 to engage an annular valve seat 27 formed to define outlet 26 of cooler bypass passageway 13. In an illustrative embodiment, valve mover spring 64 has a wide diameter end arranged to engage an annular surface provided on a top side of valve plate 30 as shown in FIG. 1.

In the illustrated embodiment, valve mover spring 64 is located in second fluid-transfer passageway 12. No “return” spring is present in first fluid-transfer passageway 11 or cooler bypass passageway 13. During assembly, before base 44 is anchored to housing 100, relief valve 62, valve mover spring 64, and temperature-responsive bypass valve 60 are passed through valve access aperture 39 into second fluid-transfer passageway 12. Then partition plate 24 is passed through valve access aperture 39 and anchored to annular seat 34 while piston 66 extends in direction 81 through fluid-transfer orifice 22. Finally, base 44 is anchored to fluid-control housing 100 after a tip of piston 66 is inserted into central piston-receiving cavity 48 of piston support plate 46 of base 44. When installed, as shown in FIG. 1, piston 66 is arranged to extend into piston chamber 38 of second fluid-transfer passageway 12 and thermal motor 70 is arranged to lie in motor chamber 40 of second fluid-transfer passageway 12.

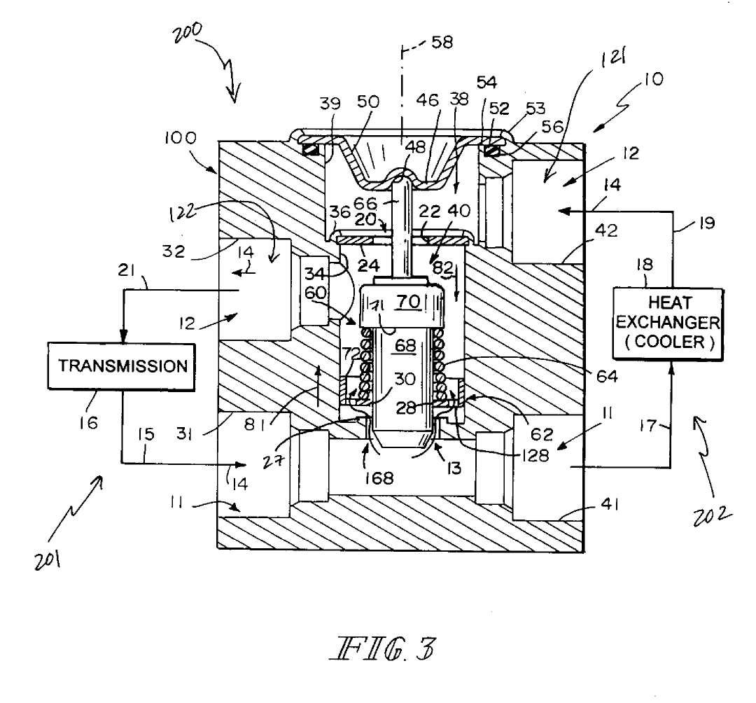

In an illustrative embodiment, thermal motor 70 is a wax motor comprising a temperature-responsive expansion agent (not shown) provided in a cavity (not shown) inside bypass valve 60 and coupled to piston 66. The expansion agent is configured to expand when heated to cause relative movement between piston 66 and thermal motor 70 to move thermal motor 70 from a low-temperature position shown in FIG. 1 to a high-temperature position shown in FIGS. 2 and 3. Thermal motor 70 is located in motor chamber 40 of second fluid-transfer passageway 12 and is exposed to cold temperatures associated with relatively cold transmission fluid 14 diverted from heat exchanger 18 to pass through cooler bypass passageway 13 during, e.g., engine startup. When transmission fluid 14 heats up, thermal motor 70 is exposed to higher temperatures associated with that relatively hot transmission fluid 14 and the temperature-responsive expansion agent in thermal motor 70 expands to move thermal motor 40 away from base 44 in direction 82 to compress valve mover spring 64 to assume a first compressed state and open fluid-transfer orifice 22 as shown in FIG. 2. This movement also causes closure plug 68 to move into and occlude plug-receiving aperture 28 formed in valve plate 30 to close cooler bypass passageway 13 as shown in FIGS. 2 and 3. It is within the scope of this disclosure to use other thermal motors comprising, for example, bimetals and temperature-activated shape-memory materials such as nitinol (nickel-titanium) material.

Whenever transmission fluid 14 extant in motor chamber 40 cools to a relatively cold temperature, the temperature-responsive expansion agent in thermal motor 70 will contract and valve mover spring 64 also located in motor chamber 40 functions as a “return spring” to urge and return thermal motor 70 to the low-temperature position shown in FIG. 1.

Relief valve 62 is exposed to hot transmission fluid 14 flowing in first fluid-transfer passageway 11 and filling cooler bypass passageway 13 while relief valve 62 is urged by valve mover spring 64 in second direction 82 to engage the annular valve seat formed to include outlet 26 of cooler bypass passageway 13. Once the pressure of hot transmission fluid 14 in closed cooler bypass passageway 13 rises to a level that is high enough to apply a force on the underside of valve plate 30 that is greater than the opposing force applied on the top side of valve plate 30 by, for example, fluid pressure and spring pressure, the valve plate 30 will rise as shown in FIG. 3 and further compress valve mover spring 64 to assume a second compressed state. This will allow pressurized transmission fluid 14 to flow through an annular channel 168 around closure plug 68 into motor chamber 40 (even though temperature-responsive bypass valve 60 remains in the lowered high-temperature position) and flows through small-diameter apertures 128 formed in valve plate 30 into second fluid-transfer passageway 12 for return to transmission 16. This flow-relief condition occurs, for example, when fluid flow through heat exchanger 18 is blocked or obstructed causing the pressure of transmission fluid 14 under relief valve 62 to rise to a level high enough to lift relief valve 62 as shown in FIG. 3.

1. A heat exchanger bypass system comprising
a fluid heater including a transmission, a fluid intake conduit coupled to the transmission, and a fluid discharge conduit coupled to the transmission,
a fluid cooler including a heat exchanger, a fluid intake conduit coupled to the heat exchanger, and a fluid discharge conduit coupled to the fluid cooler, and
a fluid regulator including a fluid-control housing and a fluid-flow controller in the fluid-control housing, the fluid-control housing being formed to include a first fluid-transfer passageway configured to conduct transmission fluid from the fluid discharge conduit of the fluid heater to the fluid intake conduit of the fluid cooler, a second fluid-transfer passageway configured to conduct transmission fluid from the fluid discharge conduit of the fluid cooler to the fluid intake conduit of the fluid heater, a partition formed to include a fluid-transfer orifice and arranged to divide the second fluid-transfer passageway into an upstream portion coupled to the fluid discharge conduit of the fluid cooler and a downstream portion coupled to the fluid intake conduit of the fluid heater, and a cooler bypass passageway arranged to interconnect the first and second fluid-transfer passageways in fluid communication, and the fluid-flow controller including a temperature-responsive bypass valve mounted for movement in the second fluid-transfer passageway to open and close the fluid-transfer orifice and a valve mover spring located in the downstream portion of the second fluid-transfer passageway and configured normally to urge the temperature-responsive bypass valve in a first direction to engage the partition to close the fluid-transfer orifice to block flow of transmission fluid discharged from the fluid cooler into the fluid heater through the downstream portion of the second fluid-transfer passageway and the fluid intake conduit of the transmission.

2. The system of claim 1, wherein the valve mover spring is arranged to lie outside of the first fluid-transfer passageway.

3. The system of claim 2, wherein the valve mover spring is arranged to lie outside of the cooler bypass passageway.

4. The system of claim 1, wherein the valve mover spring is arranged to lie outside of the cooler bypass passageway.

5. The system of claim 1, wherein the temperature-responsive bypass valve includes a body located in the downstream portion of the second fluid-transfer passageway and a piston arranged to extend through the fluid-transfer orifice formed in the partition to engage a base located in the upstream portion of the second fluid-transfer passageway, the piston is coupled to the fluid-control housing and mounted on the body for movement relative to the body, and the valve mover spring is arranged to surround a portion of the body.

6. The system of claim 5, wherein the valve mover spring is configured and arranged normally to urge the body of the temperature-responsive bypass valve in a first direction toward the base and away from the cooler bypass passageway to engage the partition to close the fluid-transfer orifice while the piston is arranged to extend through the fluid-transfer orifice into the upstream ponion of the second fluid-transfer passageway to engage the base.

7. The system of claim 6, wherein the valve mover spring is a coiled compression spring arranged to wind around a portion of the body and includes a first end arranged to engage a spring-mount flange included in the body and an opposite second end arranged to lie in close proximity to an outlet end of the cooler bypass passageway.

8. The system of claim 7, wherein the body includes a thermal motor formed to include the spring-mount flange and a closure plug arranged to extend from the thermal motor in a second direction opposite to the first direction toward the cooler bypass passageway and the coiled compression spring is arranged to wind around the closure plug.

9. The system of claim 7, wherein the cooler bypass passageway has a central axis extending therethrough and the coiled compression spring has a central axis arranged to lie in coextensive relation to the central axis of the cooler bypass passageway.

10. The system of claim 7, wherein the fluid-regulator further includes a relief valve mounted for reciprocating movement relative to the fluid-control housing in the first and second directions in the downstream portion of the second fluid-transfer passageway, the relief valve is formed to include a plug-receiving aperture opening into the cooler bypass passageway, the relief valve includes a top side arranged to engage the opposite second end of the coiled compression spring and an underside arranged to engage an annular valve seat included in the fluid-control housing and formed to define an outlet of the cooler bypass passageway, and the relief valve is arranged to move away from the annular valve seat and to compress the coiled compression spring in response to exposure of the underside of the relief valve to a first force that is opposite to and greater than a second force applied to the top side of the relief valve.

11. The system of claim 5, wherein the fluid regulator is formed to include a plug-receiving aperture opening into the cooler bypass passageway and the body includes a closure plug and a thermal motor, the closure plug is arranged to extend toward the plug-receiving aperture formed in the fluid regulator and sized to close the plug-receiving aperture, the thermal motor is coupled to the piston and to the closure plug, and the thermal motor is configured to provide means for moving the piston relative to the body while the piston remains in engagement with the base to cause the temperature-responsive bypass valve to disengage the partition to open the fluid-transfer orifice in response to exposure of the thermal motor to heat in excess of a predetermined temperature and for allowing the valve mover spring to move the body relative to the fluid-control housing and to the piston while the piston remains in engagement with the base to cause the temperature-responsive bypass valve to reengage the partition to close the fluid-transfer orifice in response to exposure of the thermal motor to a cooler temperature below the predetermined temperature.

12. The system of claim 11, wherein the fluid regulator further includes a relief valve located and mounted for movement in the downstream portion of the second fluid-transfer passageway, the relief valve is formed to include the plug-receiving aperture, the valve mover spring is arranged normally to urge the relief valve in a second direction opposite to the first direction to engage an annular valve seat formed to define an outlet of the cooler bypass passageway, the closure plug is arranged and sized to move to close the plug-receiving aperture formed in the relief valve to block flow of transmission fluid from the cooler bypass passageway into the downstream portion of the second fluid-transmission passageway upon movement of the temperature-responsive bypass valve from a low-temperature position engaging the partition to a high-temperature position disengaging the partition and compressing the valve mover spring to a first compressed state, and the relief valve is free to move in the first direction away from the annular valve seat to compress the valve mover spring further to assume a second compressed state upon exposure of the underside of the relief valve to a lifting force generated by pressure extant in the cooler bypass passageway that is greater than a lowering force applied to the top side of the relief valve and generated by exposure of the top side of the relief valve to pressure extant in the downstream portion of the second fluid-transmission passageway and a spring force exerted by the valve mover spring and to allow flow of hot transmission fluid from the cooler bypass passageway into the downstream portion of the second fluid-transmission passageway for return to the transmission via the fluid intake conduit of the fluid heater even though the temperature-responsive bypass valve remains in the high-temperature position and the closure plug closes the plug-receiving aperture formed in the relief valve.

13. The system of claim 1, wherein the fluid regulator further includes pressure-relief means for allowing flow of transmission fluid extant in the cooler bypass passageway into the downstream portion of the second fluid-transfer passageway when the temperature-responsive bypass valve has been moved in a second direction opposite to the first direction to disengage the partition to open the fluid-transfer orifice to allow flow of transmission fluid from the upstream portion of the second fluid-transfer passageway to the downstream portion of the second fluid-transfer passageway through the fluid-transfer orifice and when pressure of transmission fluid extant in the cooler bypass passageway exceeds a predetermined minimum pressure.

14. The system of claim 13, wherein the pressure-relief means includes a relief valve located in the downstream portion of the second fluid-transfer passageway and interposed between the valve mover spring and a valve seat included in the fluid-control housing and formed to define an outlet of the cooler bypass passageway opening into the downstream portion of the second fluid-transfer passageway.

15. The system of claim 14, wherein the relief valve is formed to include a central aperture opening into the cooler bypass passageway when the relief valve engages the valve seat and at least one flow-discharge aperture formed in a peripheral portion of the relief valve near a perimeter thereof.

16. The system of claim 14, wherein the relief valve is formed to include a central aperture opening into the cooler bypass passageway when the relief valve engages the valve seat and the temperature-responsive bypass valve includes a thermal motor and a closure plug coupled to the thermal motor and arranged to close the central aperture formed in the relief valve in response to movement of the temperature-responsive bypass valve to disengage the partition to open the fluid-transfer orifice and arranged to open the central aperture formed in the relief valve in response to movement of the temperature-responsive bypass valve to disengage the partition to open the fluid-transfer orifice and movement of the relief valve relative to the closure plug to disengage the valve seat.

17. A fluid regulator comprising
a fluid-control housing formed to include separate first and second fluid-transfer passageways and a cooler bypass passageway arranged to interconnect the first and second fluid-control passageways in fluid communication, the fluid-control housing also including a partition arranged to divide the second fluid-transfer passageway into upstream and downstream portions and formed to include a fluid-transfer orifice interconnecting the upstream and downstream portions in fluid communication, and
a fluid-flow controller including a temperature-responsive bypass valve and a valve mover spring associated with the temperature-responsive bypass valve, wherein the temperature-responsive bypass valve is located in the upstream and downstream portions of the second fluid-transfer passageway and the valve mover spring is located in the downstream portion of the second fluid-transfer passageway.

18. The regulator of claim 17, wherein the valve mover spring is arranged to lie outside of the first fluid-transfer passageway.

19. The regulator of claim 18, wherein the valve mover spring is arranged to lie outside of the cooler bypass passageway.

20. The regulator of claim 17, wherein the valve mover spring is arranged to lie outside of the cooler bypass passageway.
